(19) United States
(12) Patent Application Publication
(10) Pub. No.: US 2017/0227960 A1
(43) Pub. Date: Aug. 10, 2017

(54) AUTONOMOUS VEHICLE WITH MODULAR CONTROL INTERFACE

(71) Applicant: Ford Global Technologies, LLC, Dearborn, MI (US)

(72) Inventors: John P. Joyce, West Bloomfield, MI (US); Scott J. Lauffer, Northville, MI (US); Andrew Brown, Canton, MI (US); Steven R. El Aile, Sterling Heights, MI (US); Samer Abbas, Dearborn, MI (US); Darrel Alan Recker, Ypsilanti, MI (US)

(73) Assignee: Ford Global Technologies, LLC, Dearborn, MI (US)

(21) Appl. No.: 15/016,530

(22) Filed: Feb. 5, 2016

(51) Int. Cl. G05D 1/00

(52) U.S. Cl. CPC G05D 1/0061; G05D 1/0088

(57) ABSTRACT

A vehicle system includes communication circuitry programmed to communicate with a controller that is removable from an autonomous vehicle. The system further includes a processor programmed to receive control signals, which are associated with manually controlling the autonomous vehicle in a non-autonomous mode, transmitted from the controller. The processor is further programmed to output commands to at least one vehicle subsystem in accordance with the control signals transmitted from the controller while the vehicle is operating in a non-autonomous mode.

### BACKGROUND

Improvements in autonomous vehicle technology will result in less and less human interaction with the vehicle. Even a fully autonomous vehicle, however, occasionally relies on some human interaction. Accordingly, fully autonomous vehicles are equipped with traditional control interfaces such as a steering wheel, an accelerator pedal, a brake pedal, etc.

### BRIEF DESCRIPTION OF THE DRAWINGS

FIG. 1 illustrates an example autonomous vehicle with a controller interface for receiving a removable controller.

FIG. 2 is a block diagram of example components of the controller interface as well as other example vehicle components.

FIGS. 3A-3C illustrate example vehicle dashboards for receiving some removable controllers.

FIGS. 4A-4B illustrate example vehicle dashboards for receiving other removable controllers.

### DETAILED DESCRIPTION

At a certain point, autonomous vehicles will require little to no human interaction the vast majority of the time. Thus, certain controllers associated with manually operating the vehicle, such as a steering wheel, an accelerator pedal, a brake pedal, etc., may be omitted from the vehicle to, e.g., increase cabin space.

Removing some of those or other controllers may introduce other challenges, however. For instance, airbags are sometimes incorporated into the steering wheel. Further, there are times when an autonomous vehicle may need to be manually operated such as on a production line or in a service station to, e.g., drive the vehicle onto a lift or if the autonomous vehicle controller malfunctions. Therefore, completely omitting controllers from the vehicle may be too limiting under a very specific, yet significant, set of circumstances.

One way to increase cabin space in fully autonomous vehicles while not completely preventing use of particular controllers includes replacing traditional controllers with removable by-wire (or wireless) controllers. Thus, an example autonomous vehicle controller interface for removable controllers includes communication circuitry programmed to communicate with the removable controller. The system further includes a processor programmed to receive control signals, which are associated with manually controlling the autonomous vehicle in a non-autonomous mode, transmitted from the controller. The processor is further programmed to output commands to at least one vehicle subsystem in accordance with the control signals transmitted from the controller while the vehicle is operating in a non-autonomous mode.

Thus, the vehicle can generally operate in an autonomous mode without relying on inputs from the controllers and without the controllers being inside the vehicle. However, for those infrequent times a controller is needed, a controller can be temporarily installed and used to manually control the otherwise autonomous vehicle.

The elements shown may take many different forms and include multiple and/or alternate components and facilities. The example components illustrated are not intended to be limiting. Indeed, additional or alternative components and/or implementations may be used. Further, the elements shown are not necessarily drawn to scale unless explicitly stated as such.

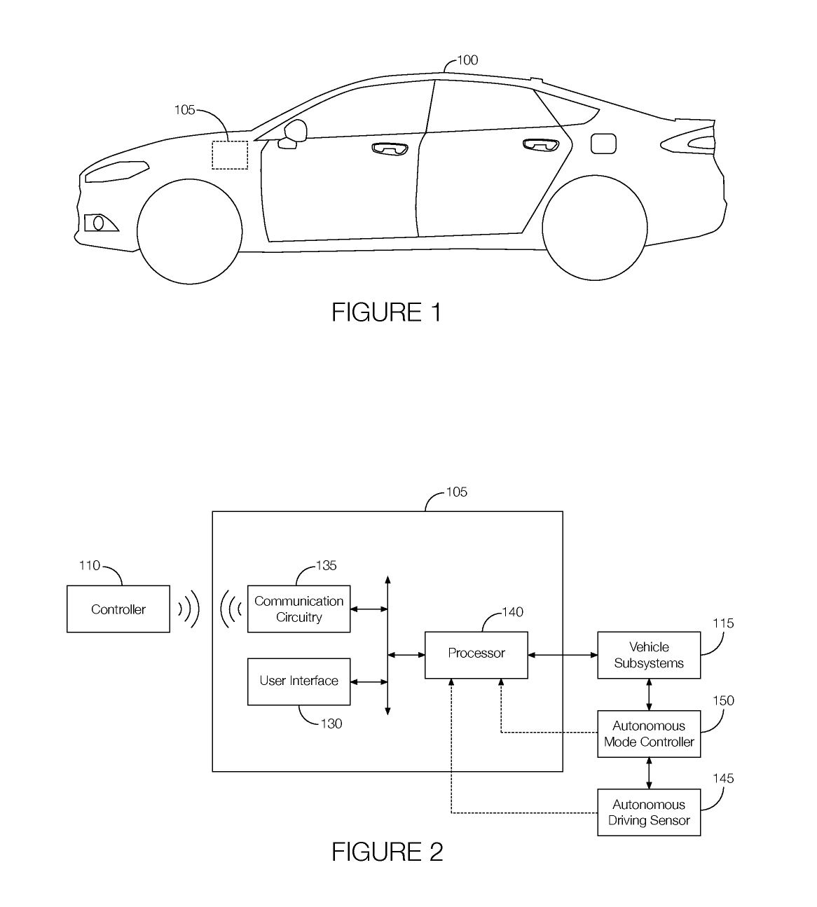

As illustrated in FIG. 1, the autonomous host vehicle 100 includes a controller interface 105 that allows controllers 110 (see FIGS. 2-4B), such as a steering wheel, an accelerator pedal, a brake pedal, etc., to be installed in an autonomous host vehicle 100 when needed. That is, the controller interface 105 may receive the controllers 110 when the autonomous host vehicle 100 needs to be manually operated. Otherwise, the controllers 110 may be omitted from the autonomous host vehicle 100.

The controller interface 105 may communicate with the controller 110 via a wired or wireless communication interface. The controller interface 105 may receive and process control signals output by the controller 110 that are associated with the manual control of the autonomous host vehicle 100. The controller interface 105 may output commands to various other vehicle subsystems 115 (see FIG. 2) in accordance with the control signals received from the controllers 110. For instance, the controller interface 105 may output commands to a steering system, engine control module, transmission control module, braking system, or the like in response to signals received from the controllers 110.

In some possible implementations, the controller interface 105 may output commands to the controllers 110. For instance, in the instance where the controller 110 includes a passive restraint with an airbag, which may be a standalone device or integrated into a removable steering wheel, the controller interface 105 may output a command causing the airbag to inflate in response to, e.g., detecting a crash.

Moreover, the controller interface 105 may arbitrate control signals output by the controllers 110 and one or more controllers controlling various operations of the autonomous host vehicle 100. By arbitrating the control signals, the controller interface 105 may determine which control signals should be output to the respective vehicle subsystems 115 to autonomously or non-autonomously (manually) control the host vehicle 100.

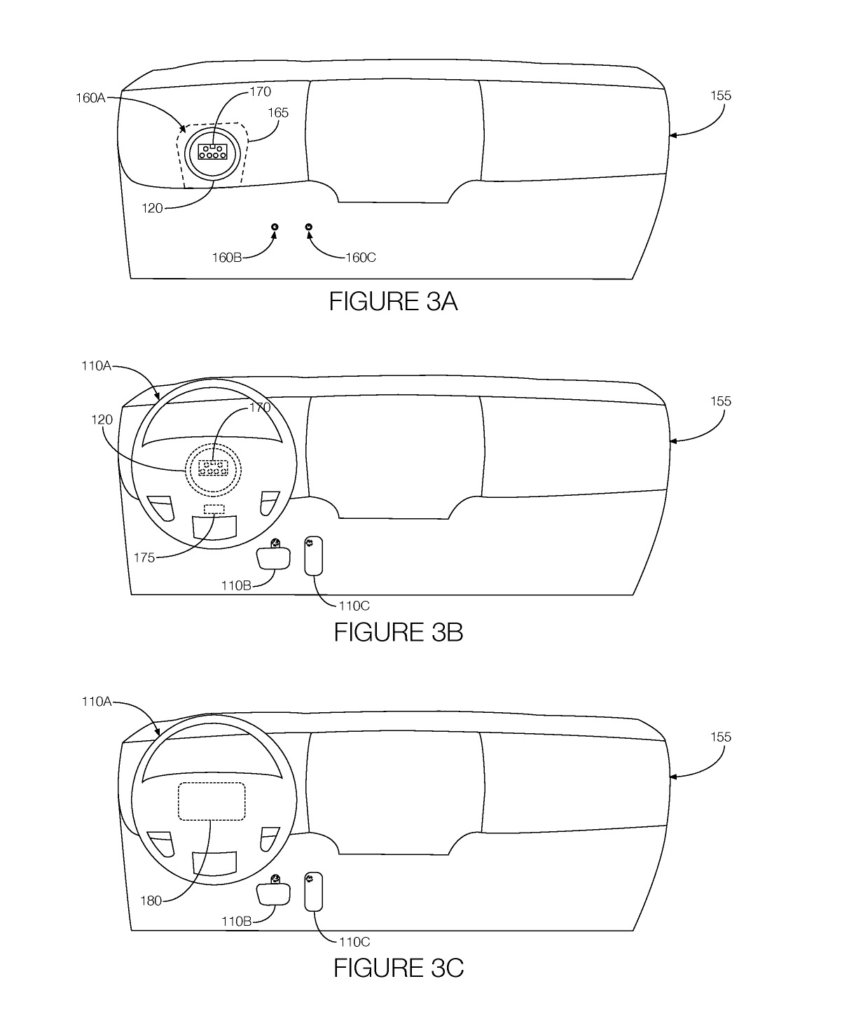

The controller interface 105 may include several physical connections for receiving the various controllers 110. For instance, one or more brackets 120 (see FIGS. 3A-3C) may be located in the cabin of the autonomous host vehicle 100, and each bracket 120 may be keyed to receive a particular controller 110 and in a particular orientation. The bracket 120 may further allow the controller 110 to be removed when it is not needed to manually control the autonomous host vehicle 100.

Further, the controller interface 105 may communicate with the controllers 110 via wired communication, wireless communication, or both. For wired communication, the controller interface 105 may include multiple wire harnesses 125 (see FIGS. 3A-3C) incorporated into or near one or more of the brackets 120 and keyed for a particular orientation. That way, when the controller 110 is plugged into the bracket 120, it may also plug into the wire harness 125. The wire harnesses 125 may be omitted for wireless communication, which may be facilitated through a wireless communication protocol such as Bluetooth®, Bluetooth Low Energy®, or the like.

The controller interface 105 may be further programmed to control whether the host vehicle 100 is operating in an autonomous mode, a non-autonomous mode, or a partially autonomous mode. If, for example, the appropriate controllers 110 are plugged into the brackets 120 and wire harnesses 125, or otherwise in communication with the controller interface 105 and ready to control the host vehicle 100 (i.e., able to output control signals), the controller interface 105 may command the host vehicle 100 to operate in a non-autonomous mode meaning that the control signals output by the controller 110 may take precedence over the control signals output by one or more controllers associated with autonomous vehicle operation.

In some instances, the controller interface 105 may only pass control signals output by the controllers 110 to various vehicle subsystems 115 in response to a user input indicating the user's intent to manually control the host vehicle 100.

Although illustrated as a sedan, the autonomous host vehicle 100 may include any passenger or commercial automobile such as a car, a truck, a sport utility vehicle, a crossover vehicle, a van, a minivan, a taxi, a bus, etc., that can operate in an autonomous (e.g., driverless) mode, a partially autonomous mode, and/or a non-autonomous mode.

FIG. 2 is a block diagram that illustrates how the controller interface 105 and controllers 110 may be incorporated into the autonomous host vehicle 100. As shown, the controller interface 105 may include a user interface 130 (which may alternatively be separate from the controller interface 105 but otherwise available in the host vehicle 100), communication circuitry 135, and a processor 140. The components of the controller interface 105 may also communicate with the controller 110, autonomous driving sensors 145, an autonomous mode controller 150, or the like.

The user interface 130 may include any number of electronic components that can present information to a vehicle occupant. In addition to presenting information, the user interface 130 may be programmed to receive user inputs. In response to a user input, the user interface 130 may output a signal, representing the user input, to the processor 140. The user interface 130 may be located in the passenger compartment of the autonomous host vehicle 100 and, in some possible approaches, the user interface 130 may include a touch-sensitive display screen. Further, the user interface may be incorporated into the controller interface 105 (as shown in FIG. 2) or may be incorporated into a different vehicle system such as an infotainment system in communication with the controller interface 105.

The communication circuitry 135 may include any number of electronic components, such as an integrated circuit and possibly other components, that facilitate wired or wireless communication between components of the controller interface 105 and the controllers 110. For wireless communication (as shown in FIG. 2), the communication circuitry 135 may be programmed to transmit wireless signals in accordance with any number of wireless communication protocols such as Bluetooth®, Bluetooth® Low Energy, or WiFi. For wired communication, the communication circuitry 135 may include an interface for receiving signals from the controller 110 when the controller 110 is plugged into a wire harness 125 (see FIGS. 3A-3C). For redundancy, the communication circuitry 135 may facilitate both wired and wireless communication with the controller 110. Further, the communication circuitry 135 may be programmed to output control signals received from the controller 110 to the processor 140.

The processor 140 may include any number of electronic components programmed to receive and process the control signals output by the controller 110. The processor 140 may process the control signals and, in some circumstances, generate commands to control the autonomous host vehicle 100 in accordance with the control signals. For instance, the processor 140 may be programmed to ignore the control signals unless a user input has been received indicating that the vehicle occupant is ready to operate the autonomous host vehicle 100 in a non-autonomous mode and that the communication circuitry 135 has already established communication with the controller 110. Under these circumstances, the processor 140 may be programmed to generate and output the commands based on the control signals, effectively causing the autonomous host vehicle 100 to operate in a non-autonomous mode.

In some instances, the processor 140 may command the autonomous mode controller 150, autonomous driving sensors 145, or both, to shut down while the autonomous host vehicle 100 is operating in the non-autonomous mode. Alternatively, the processor 140 may arbitrate the signals output by the controller 110 and autonomous mode controller 150 to determine which signals should be used to control the vehicle subsystems 115 in either an autonomous or non-autonomous mode. In yet another possible implementation, the processor 140 may provide the command signals based on the control signals to the autonomous mode controller 150, which in turn may output the command signals to the various vehicle subsystems 115. In this implementation, the autonomous mode controller 150 may give command signals output by the processor 140 higher priority than the signals the autonomous mode controller 150 would generate on its own to autonomously control the host vehicle 100.

The autonomous driving sensors 145 may include any number of electronic components that generate signals that help navigate the host vehicle 100 while the host vehicle 100 is operating in the autonomous (e.g., driverless) mode. Examples of autonomous driving sensors 145 may include a radar sensor, a lidar sensor, a vision sensor, or the like. Thus, the autonomous driving sensors 145 help the vehicle “see” the roadway and the vehicle surroundings and/or negotiate various obstacles while the vehicle is operating in the autonomous mode.

The autonomous mode controller 150 may include any number of electronic components that can control one or more vehicle subsystems 115 while the host vehicle 100 is operating in the autonomous mode. Examples of subsystems that may be controlled by the autonomous mode controller 150 may include a brake subsystem, a suspension subsystem, a steering subsystem, and a powertrain subsystem. The autonomous mode controller 150 may be programmed to control any one or more of these subsystems by outputting signals to control units associated with these subsystems. The autonomous mode controller 150 may control the subsystems based, at least in part, on signals generated by the autonomous driving sensors 145 or the command signals output by the processor 140, which has discussed above may be based on the control signals output by the controller 110.

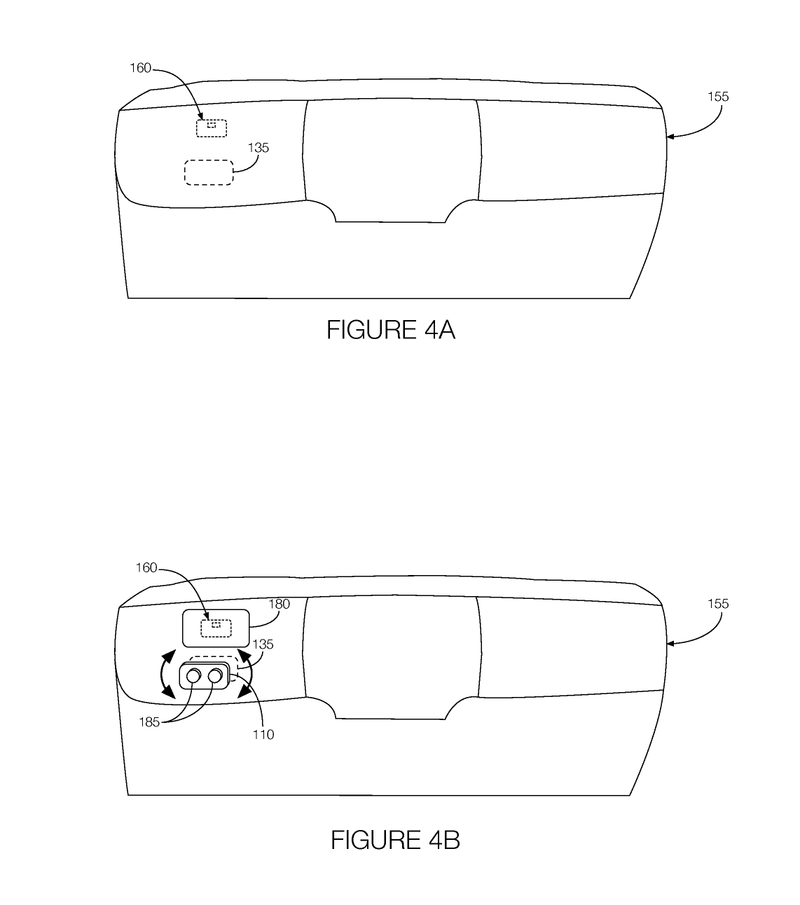

Referring now to FIGS. 3A-4B, the host vehicle 100 may include any number of controllers 110 that may be removably connected to the controller interface 105 when someone desires to operate the host vehicle 100 in a non-autonomous mode. FIGS. 3A-3C illustrate examples where various controllers 110 may be plugged into brackets 120 and wire harnesses 125 located on an instrument panel 155 inside the vehicle cabin. FIGS. 4A-4B illustrate examples where controllers 110 may be in wireless communication with the controller interface 105.

FIG. 3A illustrates an example instrument panel 155 in a host vehicle 100 with the controller interface 105. As shown, the controller interface 105 includes a port 160A for receiving a controller 110. The port 160A includes a door 165, a bracket 120, and a connector 170. The door 165 may hide the bracket 120 and connector 170 during times when no controller 110 is plugged in. Thus, the door 165 may operate on a hinge or be removable from the instrument panel 155 to expose the bracket 120 and connector 170. The bracket 120, as discussed above, may hold the controller 110 in place on the instrument panel 155 when the controller 110 is used to manually control the operation of the host vehicle 100. In some instances, the bracket 120 may be keyed to receive the controller 110 in a particular orientation. The connector 170 may include, e.g., a wire harness 125 or any other plug for facilitating signal communication between the controller 110 and the controller interface 105.

The controller interface 105 may include other ports 160 as well. For instance, as shown in FIG. 3A, the controller interface 105 includes a port 160B for receiving a controller 110 serving as a brake pedal and a port 160C for a controller 110 serving as an accelerator pedal. The port 160B and the port 160C may each include a bracket 120 and connector 170, one or both of which may be keyed to receive the brake pedal and accelerator pedal, respectively, in a particular orientation for proper usage and signal communication.

FIG. 3B illustrates an implementation where the door 165 has been removed and a controller 110A (shown as a steering wheel) is inserted into the bracket 120 and connected to the connector 170 of port 160A. Further, other controllers 110B and 110C, shown as a brake pedal and accelerator pedal, respectively, are inserted into the brackets 120 and connectors 170 of port 160B and port 160C, respectively. Therefore, FIG. 3B illustrates an implementation where the host vehicle 100 includes some controllers 110 that may allow the host vehicle 100 to be operated manually.

When the controller 110 includes a steering wheel or any other type of steering device, the controller 110 may include an accelerometer or other type of motion sensor 175 programmed to detect movement, including measuring an angle request. The angle request may include, e.g., the desired angle of rotation as if the user were turning a traditional steering wheel. The motion sensor 175 may be programmed to transmit, via a wired or wireless communication link, the angle request to the communication circuitry 135. The communication circuitry 135 may, in turn, transmit the angle request to the processor 140 so that the processor 140 may control one or more vehicle subsystems 115, such as a steering subsystem, in accordance with the angle request.

When the controller 110 includes an accelerator or brake pedal, such as shown in FIG. 3B, each pedal may include an encoder that can be used to determine the pedal position. The encoder may output a pedal position signal representing the pedal position to the processor 140, via the communication circuitry 135 by way of a wired or wireless connection. The processor 140 may be programmed to output commands to one or more vehicle subsystems 115, such as a throttle or brake controller depending on which pedal is being pressed, in accordance with the pedal position signal.

FIG. 3C illustrates an installed controller 110 with an integrated passive restraint 180, such as an airbag. When the controller 110 is not installed, and when the autonomous host vehicle 100 is operating in an autonomous mode, the occupants may not be located near the port 160A or even facing the port 160A. Therefore, a passive restraint 180 may be omitted from that location. When the controller 110 is installed and an occupant is using it to manually control the host vehicle 100, a passive restraint 180 may be desired at that location. In the example of FIG. 3C, the passive restraint 180 is integrated into the controller 110 and may receive signals output by the controller interface 105, a vehicle subsystem 115, or both. Thus, when an impact is detected, a signal may be transmitted to the passive restraint 180 that causes the passive restraint 180 to deploy. The signal communication with the passive restraint 180 may be facilitated via the connector 170 associated with port 160A, the communication circuitry 135 of the controller interface 105, or a combination of both.

Referring now to FIGS. 4A-4B, wireless communication between the controller interface 105 and the controller 110 may permit the ports 160 to be excluded from the instrument panel 155. Instead, the controller 110 may include a wireless transmitter that wirelessly communicates with the communication circuitry 135 of the controller interface 105. In this possible implementation, the controller 110 and communication circuitry 135 may include near field communication (NFC) technology to facilitate the wireless communication. If a passive restraint 180 is desired, a separate port 160 may be used to receive and communicate with the passive restraint 180, however.

Wireless communication with the controller 110 may permit the controller 110 to take a different form than a traditional steering wheel. Examples of non-traditional controllers 110 may include, e.g., a game controller, a joystick, a smartphone, a tablet computer, or any other electronic device that can include an accelerometer or other type of motion sensor 175 or directional control and that can wirelessly communicate with the controller interface 105. While the same is true for the implementation shown with respect to FIGS. 3A-3C, the wireless interface of FIGS. 4A-4B does not rely on a bracket 120 and wired electrical connection, which means that different controllers 110 may be used on the same host vehicle 100. Further, the outputs of a non-traditional controller may not be limited to a particular function. That is, the outputs of a non-traditional controller may relate to, e.g., longitudinal motion control, acceleration, braking, wheel torque, accelerator or brake pedal position, etc.

The controller 110 of FIGS. 4A-4B may include various buttons 185. In some implementations, such as with a gaming controller, the buttons 185 may be physically incorporated into the controller 110. In other instances, such as with a smartphone or other controller 110 with a touch-sensitive display screen, the buttons 185 may be virtually presented on the display screen and respond to user inputs provided by touching the virtual buttons 185. Further, by including a motion sensor 175, motions associated with steering the host vehicle 100 may be detected by, e.g., rotating the controller 110 about a particular axis.

Further, even though one controller 110 may wirelessly communicate with the controller interface 105, others, such as the accelerator pedal and brake pedal, may still be connected via the bracket 120 and wired connection. Alternatively, as is the case with FIGS. 4A-4B, those other controllers 110 may be omitted with their functionality replaced by, e.g., the real or virtual buttons 185 of the wireless controller 110.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OSX and iOS operating systems distributed by Apple Inc. of Cupertino, Calif., the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computing devices generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A vehicle system comprising:
communication circuitry programmed to communicate with a controller that is removable from an autonomous vehicle; and
a processor programmed to receive control signals transmitted from the controller,
wherein the control signals are associated with manually controlling the autonomous vehicle in a non-autonomous mode,
wherein the processor is programmed to output commands to at least one vehicle subsystem in accordance with the control signals transmitted from the controller while the vehicle is operating in a non-autonomous mode.

2. The vehicle system of claim 1, wherein the controller includes at least one of a steering wheel, an accelerator pedal, and a brake pedal.

3. The vehicle system of claim 1, wherein the processor is programmed to arbitrate control signals transmitted from the controller and signals output by an autonomous mode controller and output the commands to the at least one vehicle subsystem based at least in part on how the control signals and signals output by the autonomous mode controller are arbitrated.

4. The vehicle system of claim 1, further comprising a bracket configured to receive the controller, wherein the controller is removably mounted to the bracket.

5. The vehicle system of claim 1, further comprising a wire harness configured to plug the communication circuitry into the controller.

6. The vehicle system of claim 5, wherein the control signals are transmitted to the communication circuitry via the wire harness.

7. The vehicle system of claim 1, wherein the communication circuitry is programmed to wirelessly communicate with the controller.

8. The vehicle system of claim 1, further comprising:
at least one autonomous driving sensor; and
an autonomous mode controller programmed to control the at least one vehicle subsystem while operating in an autonomous mode.

9. The vehicle system of claim 8, wherein the processor is programmed to command the autonomous mode controller to operate in a non-autonomous mode in response to receiving the control signals from the controller.

10. The vehicle system of claim 1, wherein the controller includes a steering wheel having a motion sensor programmed to measure an angle request, and wherein the steering wheel is programmed to wirelessly transmit the angle request to the communication circuitry and wherein the processor is programmed to control the at least one vehicle subsystem at least in part in accordance with the angle request.

11. The vehicle system of claim 1, wherein the controller includes an accelerator pedal in wireless communication with the communication circuitry and programmed to wirelessly transmit a pedal position signal to the communication circuitry, and wherein the processor is programmed to control the at least one vehicle subsystem at least in part in accordance with the pedal position signal.

12. A vehicle system comprising:
at least one autonomous driving sensor;
communication circuitry programmed to communicate with a controller that is removable from an autonomous vehicle; and
a processor programmed to receive control signals transmitted from the controller,
wherein the control signals are associated with manually controlling at least one vehicle subsystem when the vehicle is operating in a non-autonomous mode,
wherein the processor is programmed output commands to control the at least one vehicle subsystem in accordance with signals output by the at least one autonomous driving sensor while the autonomous vehicle is operating in an autonomous mode and output commands to control the at least one vehicle subsystem in accordance with the control signals transmitted from the controller while the autonomous vehicle is operating in a non-autonomous mode.

13. The vehicle system of claim 12, wherein the controller includes at least one of a steering wheel, an accelerator pedal, and a brake pedal.

14. The vehicle system of claim 12, wherein the processor is programmed to arbitrate control signals transmitted from the controller and signals output by the autonomous mode controller and output the commands to the at least one vehicle subsystem based at least in part on how the control signals and signals output by the autonomous mode controller are arbitrated.

15. The vehicle system of claim 12, further comprising a bracket configured to receive the controller, wherein the controller is removably mounted to the bracket.

16. The vehicle system of claim 12, further comprising a wire harness configured to plug the communication circuitry into the controller, wherein the control signals are transmitted to the communication circuitry via the wire harness.

17. The vehicle system of claim 12, wherein the communication circuitry is programmed to wirelessly communicate with the controller.

18. The vehicle system of claim 12, wherein the processor is programmed to command the autonomous mode controller to operate in the non-autonomous mode in response to receiving the control signals from the controller.

19. The vehicle system of claim 12, wherein the controller includes a steering wheel having a motion sensor programmed to measure an angle request, and wherein the steering wheel is programmed to wirelessly transmit the angle request to the communication circuitry and wherein the processor is programmed to control the at least one vehicle subsystem at least in part in accordance with the angle request while the autonomous vehicle is operating in the non-autonomous mode.

20. The vehicle system of claim 12, wherein the controller includes an accelerator pedal in wireless communication with the communication circuitry and programmed to wirelessly transmit a pedal position signal to the communication circuitry, and wherein the processor is programmed to control the at least one vehicle subsystem at least in part in accordance with the pedal position signal while the autonomous vehicle is operating in the non-autonomous mode.
